(19) United States
(12) Patent Application Publication
(10) Pub. No.: US 2003/0111795 A1
(43) Pub. Date: Jun. 19, 2003

(54) Leak path device, and methods of constructing and utilizing same

(76) Inventors: Eric S. Glassman, Clarence, NY (US); Edward J. Kowalcyk, Oakfield, NY (US)

Correspondence Address: Irving M. Weiner, Weiner & Burt, P.C., 635 N. US-23, P.O. Box 186, Harrisville, MI, 48740, US

(21) Appl. No.: 10/326,783

(22) Filed: Dec. 19, 2002

Related U.S. Application Data
(60) Provisional application No. 60/342,797, filed on Dec. 19, 2001.

(51) Int. Cl. F16J 15/16

(52) U.S. Cl. 277/320

(57) ABSTRACT

A leak path device included in the fabrication and design of a part which allows air or fluid to escape to the outer perimeter of the part. One such path is an outward spiral leak path which can be produced on screw machine equipment without secondary fabrication operations.

The present utility patent application claims priority from U.S. Provisional Patent Application Serial No. 60/342,797 filed Dec. 19, 2001.

The present invention relates generally to a leak path device, and methods of constructing and utilizing same.

More particularly, the present invention relates to a leak path for heightened test indication whether or not a sealing member is present.

### BACKGROUND OF THE INVENTION

In general, a face seal constitutes any sealing mechanism which has a seal groove cut into a plane surface which mates with another plane surface having no such groove. The sealing occurs due to the groove depth being less than the cross section of the sealing material, thus compressing the sealing material.

In some assemblies, a seal may be formed even though the sealing material has not been included in the assembly. This mainly occurs when one of the plane surfaces is fabricated from a material which is softer than the material of the mating plane surface. For example, when the first plane surface is formed of plastic, and the second mating plane surface is formed of steel. Frequently, this sealing condition may not be known even though the joint is leak tested.

The purpose of the present invention is to ensure detection of such a sealing condition, and other sealing conditions.

It is a desideratum of the present invention to avoid the animadversions of the prior art techniques and devices.

### SUMMARY OF THE INVENTION

The present invention provides a new and useful leak path device which may be included in the design of the part and which allows air or fluid to escape to the outer perimeter of the part.

The present invention provides a novel and unique leak path device to insure detection of a sealing condition between a first member and a second member, comprising: a sealing condition between a first member and a second member; a predetermined leak path formed in at least one of said first and second members; and said predetermined leak path comprises a channel communicating between said sealing condition and a predetermined outer perimeter of at least one of said first and second members, which channel allows air or a fluid to escape to said predetermined outer perimeter of at least one of said first and second members.

It is a primary object of the present invention to provide such a leak path which is designed as an outward spiral leak path and which may be produced concurrently with the part manufacture without secondary operations on the part.

It is a further object of the present invention to provide such an outward spiral leak path wherein the rate of exit of the spiral leak path is greater than or equal to the distance to be transversed per one-half revolution.

Another object of the present invention is to provide such a spiral leak path wherein the distance to be transversed by a tool of screw machine equipment for forming a part can be defined as a point starting at the mid-point of the seal groove width, continuing to a point equal to the diameter representing the outermost feature of the part plus one-half the seal groove width.

An additional object of the present invention is to provide such a spiral leak path wherein the cross sectional shape of the leak path may be any suitable cross section, such as, for example, U-shaped, V-shaped, or any similar shaped channel, as long as the inside edge of the groove clears the outermost feature of the part when it reaches the end of its traverse.

A further object of the present invention is to provide a leak path for heightened test indications even when no sealing material is present.

The present invention possesses many other advantages and features which will become more apparent to those persons skilled in this area of technology and to others when reading the detailed description of a preferred exemplary embodiment of the present invention as set forth hereinbelow in conjunction with the accompanying drawings.

### BRIEF DESCRIPTION OF THE DRAWINGS

FIG. 1 illustrates a medial section of a device including a preferred embodiment of the present invention.

FIG. 2 depicts a sectional view of the FIG. 1 device taken along the line 2-2 of FIG. 1.

FIG. 3 illustrates an exploded view of the leak path from that portion of FIG. 2 indicated by the lead line 3.

### DETAILED DESCRIPTION OF THE INVENTION

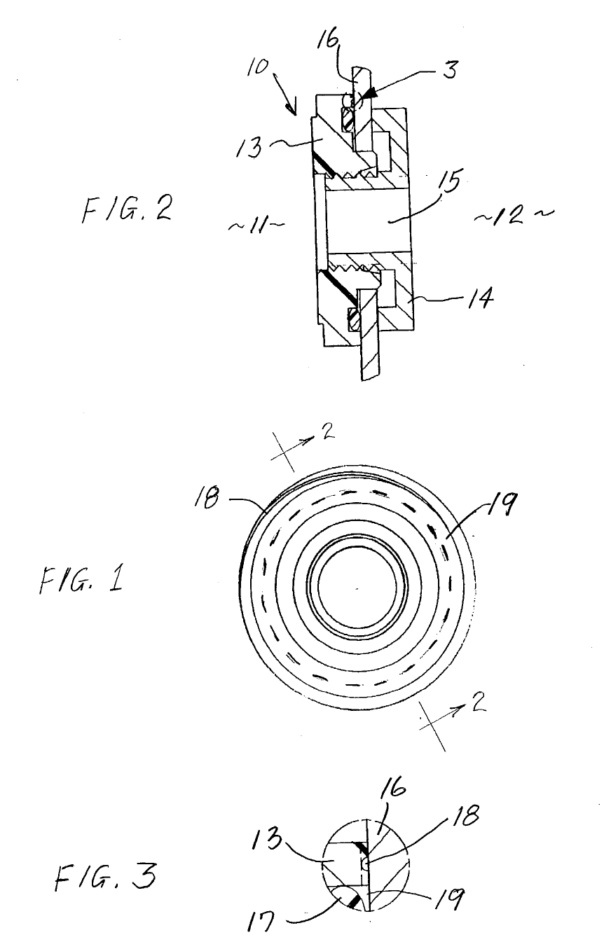

With reference to FIGS. 1 and 2, there is shown an assembly 10 connecting a tank fluid space 11 to atmosphere 12.

The assembly 10 includes a fitting 13, a fitting nut 14, a fluid path15 , a bulkhead 16, and a seal groove 19, and a sealing member 17 such as an O-ring. A leak path 18 is included to allow air or fluid to escape to the outer perimeter of the assembly 10.

A preferred embodiment of the invention comprises an outwardly spiral leak path 18, which may be produced on screw machine equipment without secondary operations.

The direction of the spiral rotation of the leak path 18 is not critical. A preferred embodiment of the invention provides a spiral leak path 18 traveling through approximately 180° of rotation.

FIG. 3 shows the arrangement of the leak path 18 and its proximity to the seal groove 19.

In some assemblies, a seal may be formed even though the sealing member 17 has not been included in the assembly 10. This primarily occurs when one of the plane surfaces is of a softer material than the other. Oftentimes, this condition may not be known even though the joint is leak tested.

The rate of exit of the spiral leak path 18 is preferably greater than or equal to the distance to be transversed per one-half revolution. The distance to be transversed by a tool of screw machine equipment can be defined as a point starting midpoint of the seal groove 19 width, continuing to a point equal to the diameter representing the outermost feature of the assembly 10 plus one-half the seal groove 19 width. However, it should be understood that the necessary distance transversed by the leak path 18 need merely be from the sealing conditional groove 19 to the outer periphery of the part.

The present invention covers other forms and shapes of leak paths 18. For example, the simplest form would be straight channel radiating straight outwardly across the outward face; however this would require a secondary operation.

There has been illustrated in the accompanying drawings and described hereinabove only one unique and novel preferred embodiment of the present invention which can be constructed in many different configurations, arrangements of components, sizes, and shapes. It should be understood that many changes, modifications, variations, and other uses and applications will become apparent to those persons skilled in this particular area of technology and to others after having been exposed to the present patent specification and accompanying drawings.

Any and all such changes, modifications, variations and other uses and applications which do not depart from the spirit and scope of the present invention are therefore covered by and embraced within the present invention and patent application.

1. A leak path device to ensure detection of a sealing condition between a first member and a second member, comprising:
a sealing condition between a first member and a second member;
a predetermined leak path formed in at least one of said first and second members; and
said predetermined leak path comprises a channel communicating between said sealing condition and a predetermined outer perimeter of at least one of said first and second members, which channel allows air or a fluid to escape to said predetermined outer perimeter of at least one of said first and second members.

2. A device according to claim 1, wherein:
said sealing condition includes a seal groove.

3. A device according to claim 1, wherein:
said first member is fabricated from a material which is softer than a material from which said second members is fabricated; and
said sealing condition is formed when said first and second members come into intimate contact with each other.

4. A device according to claim 1, wherein:
said first member includes a predetermined surface adapted to come into intimate contact with said second member; and
said channel is formed in said predetermined surface of said first member.

5. A device according to claim 2, wherein:
said first member includes a predetermined surface adapted to come into intimate contact with said second member; and
said channel is formed in said predetermined surface of said first member.

6. A device according to claim 3, wherein:
said first member includes a predetermined surface adapted to come into intimate contact with said second member; and
said channel is formed in said predetermined surface of said first member.

7. A device according to claim 1, wherein:
said first member and said second member have a common axis; and
said predetermined leak path is disposed completely within no more than 180 degrees of rotation relative to said common axis.

8. A device according to claim 2, wherein:
said first member and said second member have a common axis; and
said predetermined leak path is disposed completely within no more than 180 degrees of rotation relative to said common axis.

9. A device according to claim 3, wherein:
said first member and said second member have a common axis; and
said predetermined leak path is disposed completely within no more than 180 degrees of rotation relative to said common axis.

10. A device according to claim 4, wherein:
said first member and said second member have a common axis; and
said predetermined leak path is disposed completely within no more than 180 degrees of rotation relative to said common axis.

11. A device according to claim 5, wherein:
said first member and said second member have a common axis; and
said predetermined leak path is disposed completely within no more than 180 degrees of rotation relative to said common axis.

12. A device according to claim 6, wherein:
said first member and said second member have a common axis; and
said predetermined leak path is disposed completely within no more than 180 degrees of rotation relative to said common axis.

13. A device according to claim 1, wherein:
said predetermined leak path comprises an outwardly spiral leak path.

14. A device according to claim 2, wherein:
said predetermined leak path comprises an outwardly spiral leak path.

15. A device according to claim 3, wherein:
said predetermined leak path comprises an outwardly spiral leak path.

16. A device according to claim 4, wherein:
said predetermined leak path comprises an outwardly spiral leak path.

17. A device according to claim 5, wherein:
said predetermined leak path comprises an outwardly spiral leak path.

18. A device according to claim 6, wherein:
said predetermined leak path comprises an outwardly spiral leak path.

19. A device according to claim 7, wherein:
said predetermined leak path comprises an outwardly spiral leak path.

20. A device according to claim 8, wherein:
said predetermined leak path comprises an outwardly spiral leak path.
